(19) United States
(12) Patent Application Publication
(10) Pub. No.: US 2020/0086436 A1
(43) Pub. Date: Mar. 19, 2020

(54) TOOL SPINDLE

(71) Applicant: Adolf KOCHSIEK, Leopoldshöhe (DE)

(72) Inventor: Adolf KOCHSIEK, Leopoldshöhe (DE)

(21) Appl. No.: 16/084,082

(22) PCT Filed: Mar. 10, 2017
(86) PCT No.: PCT/EP2017/055744

§ 371 Date: Sep. 11, 2018

(30) Foreign Application Priority Data
Mar. 11, 2016 (EP) 16159864.4

(51) Int. Cl. B23Q 1/70; B23B 29/034; B23Q 27/00

(52) U.S. Cl. CPC B23Q 1/70; B23Q 27/00; B23B 29/034

(57) ABSTRACT

The disclosure relates to a tool spindle with a spindle housing, a rotary drive, a tool receiving unit, wherein the tool receiving unit is arranged within the spindle housing and is movable with respect to the housing, which tool receiving unit can be used multi-functionally, and with which both conventional machining operations such as drilling and milling as well as turning and novel machining operations, such as cam turning, can be performed without damaging the spindle and with high industrial manufacturing quality.

### CROSS-REFERENCE TO RELATED APPLICATIONS

This application is a National Stage of International Application No. PCT/EP2017/055744 filed on Mar. 10, 2017, and published in English as WO 2017/153596 A1 on Sep. 14, 2017. This application claims the priority to European Patent Application No. 16159864.4, filed on Mar. 11, 2016. The entire disclosures of the above applications are incorporated herein by reference.

### FIELD

The present disclosure relates to a tool spindle. Such tool spindles are used in machines for machining workpieces and serve to receive machining tools. The machining tools are usually accommodated and firmly clamped via a tool interface present in the tool spindle.

### BACKGROUND

This section provides background information related to the present disclosure which is not necessarily prior art.

The most varied devices for machining workpieces are known in the art. On the one hand, these include lathes. With these, the workpiece is rotated, while the tool is moved in a stationary position axially and radially with respect to the workpiece. By this method, the workpiece will be formed with round, rotationally symmetric contours.

Furthermore, drilling machines are known where a drill rotates and is propelled against a stationary workpiece. In this way, bores are formed in the workpiece.

Furthermore, milling machines are known. A rotating milling head is moved axially and radially with respect to a stationary workpiece, thereby producing milling grooves, milling surfaces, freeform surfaces, and the like in the workpiece.

It has also been known to use corresponding tool spindles in machining centres. These are then automatically loaded with the corresponding tools.

Finally, also machines for producing non-round contours are known. This is called cam turning. Both a rotating tool with a cutting head and the rotating workpiece are controlled relative to each other with regard to their revolutions. In this manner, non-round contours are produced on the workpiece. Such methods have been known for instance from EP-PS 0097346 or EP 0907458 B2.

A tool spindle usually comprises a rotary drive, for instance a driving motor, a rotating driving axle driven by the driving motor, and, after a transmission chain, an output axle, into which a tool receiving unit is integrated. In such a spindle, the centre of the driving axle is the centre of the tool at the same time. When inserting a drill or a mill, it is possible to carry out corresponding machining operations. Such previously known spindles cannot be used for cam turning, since the tool cutting edge cannot be moved on its circular flight path relative to the centre of the tool spindle.

In order to turn with such devices, a tool must be aligned with its cutting edge, and the output axle must be decoupled from the driving axle and clamped, or the drive must be set to a positioning control mode. During turning, considerable momentums and forces are acting on the cutting tool, both radially and axially, which must be absorbed by the system.

In cam turning devices, on the other hand, a workpiece is clamped in a workpiece spindle and rotates about a workpiece axis of rotation. The workpiece in turn is positioned in a tool spindle and rotates about a tool axis of rotation. The spindles are arranged on sliding frames and slides in a manner known in the art, so that relative axial and radial movements between the workpiece and the tool can be performed. The tool itself does not necessarily move about a central axis in relation to the workpiece, but also performs rotational movements about an adjustable eccentric axis. In addition, a so-called tool flight circle can be changed. The different adjustments influence the number of corners in the non-round contour (speed ratios), the depth of penetration of the tool (flight circle) etc.

With cam turning devices, it is on principle possible to drill and mill as well as turn normally by keeping the rotational axes correspondingly constant as in conventional devices; however, during drilling and milling, all forces act on the positioning control of the axes, and during turning, considerable torsional and transverse forces act on the device, so that no exact industrial production is possible.

Previously known devices for cam turning are limited in terms of the possible speeds, since with increasing speeds, imbalance can have considerable impacts. Moreover, they are limited with regard to use, because the effect of coolant supply from the outside is only insufficient. In many individual cases, the rigidity of the systems is not sufficient.

Conventional lathes and machining centres which can turn, drill, and mill have limits with regard to machining. It is not possible to produce conical or stepped forms, and chamfers cannot be produced without problems. Non-round parts cannot be produced at all. Precision corrections, for instance by turning inside diameters of bores which are slightly too small or the like are not possible, either. If an additional device, such as an inserted tool, is inserted in conventional tool spindles, cam turning may well be possible, the size, however, is automatically increased, thereby making the usually automatic change of tools impossible. In other words, it requires set-up work, and retooling leads to the corresponding downtimes; in addition, working space is lost, which limits the possible use of the machine. Moreover, such an arrangement is not sufficiently rigid for the occurring forces, and limited in terms of processing time and rotational speeds.

A machine tool is described in U.S. Pat. No. 4,370,080. It has three drives which are used for different purposes. A drive 23 serves for total rotation of the unit, a drive 66 for tool rotation, and a drive 45 for tool pivoting. The workpiece rotates by a double rotation of a spindle in a spindle caused by combining the drives 23 and 66. A direct adjustment without further transmission elements, gears and the like is not possible. In addition, two separate shafts are coupled. The device is generally very complex and cost-intensive and has in particular a structure which is hard to control and which hampers precise industrial production.

A corresponding machine tool has been known from DE 103 48 801 B3. By addressing two drives, both a tool rotation and an adjustment are realised. For this purpose, two spindles are used relatively rotatably, which makes the device complex and expensive. In addition, control is difficult, as control is exercised by speed differentials. Furthermore, an anti-rotation lock is required. On the whole, the device is primarily designed and suitable for drilling.

A machine tool for the production of grooves by milling procedures has been known from DE 2422984 A1. Here, two spindles are moved relative to each other and are also controlled by a speed differential. Groove machining is performed by means of wave milling.

Devices known from prior art are sensitive and hard to control with regard to imbalances. In addition, external supply lines for cooling lubricant are required. Depending on the machining process, the axes need to be clamped or locked, and an automatic change of tools is generally not possible.

### SUMMARY

This section provides a general summary of the disclosure, and is not a comprehensive disclosure of its full scope or all of its features.

Starting from the state of the art described above, the disclosure is based on the object to provide a tool spindle which can be used multi-functionally, and which can be used to perform both conventional machining operations such as drilling, milling and turning and novel operations such as cam turning, each without damaging the spindle, and with high industrial manufacturing quality. At the same time, great importance should be attached to a compact design so as to not restrict the working space.

For the technical solution, the disclosure proposes a tool spindle having the features of claim 1. Other advantages and features result from the sub-claims.

According to the disclosure, therefore, a conventional tool spindle is further developed such that not only its use for the previous functions is improved, i. e. drilling, turning, milling, but moreover, it can turn non-round workpieces in combination with the main spindle. This is achieved without increasing the size, automatic changes of tools are possible without any problem, and the novel tool spindle becomes multi-functional.

According to the disclosure, the tool adjustment device is accommodated in the shaft of the tool spindle. This tool adjustment device contains a tool adjustment unit which is movable with respect to the shaft, wherein this does not mean a rotation about the axis of rotation, but it is displaceable, pivotable, and the like, parallel or transverse to the rotational axis of the shaft. It also comprises a tool receiving device or unit, in which a tool can be inserted.

The disclosure proposes that the tool receiving unit comprises an adjustment unit which is movable with respect to the shaft about an axis positioned transverse or parallel to the rotational axis.

This embodiment according to the disclosure results in a number of advantages. It is now possible to arrest the adjustment unit relative to the shaft, i. e. to lock it or to jam it in a continuously variable manner. In this manner, there is no danger that the positioning control and the axes will be affected during drilling and milling. Precision and rigidity of the tool clamping are thereby improved.

A direct measuring system can be integrated without any problem, whereby it is also possible to transmit the measuring system signals without contact.

The tool receiving unit can be designed such that an automatic change of tools is enabled by integrating a corresponding automatic clamping device. The correct position of the tool can be controlled by a device which detects when the tool is clamped.

The drive of the adjustment unit may be designed as a hydraulic drive. So for instance the position of the tool cutting edge can be controlled hydraulically.

By the embodiment of the tool spindle, in particular of the shaft, it is possible to provide channels for hydraulics, pneumatics, and in particular for the supply of coolingant through the spindle.

A cylindrical spindle housing offers defined conditions for inserts, modularisation, and additional units.

It is easily possible to perform an imbalance compensation.

Due to the possibility of mechanical clamping or locking of the tool adjustment unit it is possible to realise an extremely rigid connection, which makes it possible to achieve optimal results in particular during milling and drilling. According to a beneficial proposal of the disclosure, the locking mechanism may be designed as a ball ring lock. This locking mechanism locks the receiving unit with respect to the shaft. Another locking mechanism or continuously variable jamming of the shaft per se makes it possible to achieve a rigidity of the shaft transmissions and bearings which is extremely supportive during turning, i. e. with fixed tool spindle, also when using multiple-edged tools, as herein, rigidity is of particular importance. In this manner, so-called mini turret heads can be realised which significantly reduce the time for changing the tools and, in addition, increase the number of tools in the tool magazine. This locking mechanism, too, may be designed as a ball ring lock, a continuously adjustable locking mechanism, or as a combination of both.

The spindle according to the disclosure can be used in conventional lathes. It is supplemented there as an additional spindle. This will render the lathe multi-functional, i. e. it now has a powerful driven tool for use for milling and drilling, the production of eccentric mold bores or mold pins, and finally the production of non-round shafts and hubs. In addition, all of the functions of the basic machine per se are fully preserved.

The spindle according to the disclosure can also be used in conventional machining centres. Here, the tool spindle of the machining centre is replaced by the tool spindle according to the disclosure. In machining centres, the workpiece is usually firmly clamped and does not rotate, as opposed to the lathe.

By the use of the spindle according to the in conventional machining centres, the functional range of the centre can be significantly increased. On the one hand, the functionality of a lathe is integrated into a machining centre. Now, machining operations can be performed with one tool which would otherwise not be possible at all in the machine or only with an extremely extensive use of tools, i. e. by the use of many different machining tools. This is based on the performance of the spindle according to the disclosure in relation to rotational speed, torque and displacement paths.

With the use of the spindle in modern turning/milling centres, the turning/milling spindle of the centre is replaced by the spindle according to the disclosure. Turning/milling centres combine the functions of turning and milling in one machine, whereby a workpiece is clamped in a chuck of a main spindle. It rotates or may be machined in a stationary position. Milling is performed at standstill or at a slow rotation. Through the use of the spindle according to the disclosure in such a machine, it is now possible to produce non-round shafts and hubs, and in addition also to produce eccentric mold bores or mold pins. Furthermore, the mini turret function is supported, and locking mechanisms with higher rigidity and stability are provided during turning and milling without affecting the basic functions of the machine or restricting the working space.

The tool spindle according to the application provides significant advantages over the prior art. In the so-called rotary joint, i.e. the central passage, there are primarily hydraulic lines. These serve to provide hydraulic pressure for locking and moving the tool adjustment axle of the adjustment device. Further, the hydraulic pressure for the so-called tool clamping is provided, by which the tool is firmly locked in position. Hydraulic pressure for imbalance compensation is also provided, if applicable. Hereby, for instance ring segments can be adjusted in corresponding annular grooves. Coolant/lubricant, which is also provided through the rotary joint, can be supplied at high pressure. Moreover, pneumatic pressure for tool contact control is passed through, and finally lines for the measuring system, namely both power and signal lines.

The measuring system can transmit the signals by radio in a beneficial manner, so that a central controller can receive the signals at high speed. Due to the non-contact transmission, higher rotational speeds are possible, and the transmission is maintenance-free. High speeds are required for cam turning and the full use of modern tools.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic partial sectional view of an exemplary embodiment of a tool spindle according to the disclosure;

FIG. 2 is a view of the tool receiving device according to FIG. 1;

FIG. 3 is an enlarged representation of the front area of an exemplary embodiment of a tool spindle according to the disclosure;

FIG. 4 is an overview representation of the tool spindle according to the disclosure, and

FIG. 5 is a top view onto the spindle according to FIGS. 3 and 4.

In the figures, identical elements are identified by the same reference numerals. The spindle consists of rotationally symmetric components, so that for the purpose of greater clarity, the elements are provided with reference numerals on one side of a centre line.

### DETAILED DESCRIPTION

Example embodiments will now be described more fully with reference to the accompanying drawings.

An exemplary embodiment of a tool spindle 1 according to the disclosure comprises a spindle housing 2 with a corresponding add-on unit 3. With the add-on unit 3, the tool spindle 1 may be arranged in a manner known in the art on sliding frames, slides, swivel bearings and the like, depending on the machine and the application. Alternatively, the tool spindle may also be accommodated in a receiving sleeve provided by the machine tool.

A power unit 4 with a corresponding motor is formed within the housing. Ultimately, the driving forces are applied to a shaft 5.

A tool adjustment device 6 is directly integrated into shaft 5, in which a tool adjustment unit 14 is integrated. A tool receiving unit 11 passes through a kind of lock 15. A tool interface accommodates a machining tool. The tool adjustment device 6 is directly integrated into shaft 5, so that the device can be set in rotary motion. By means of the piston assembly 12, the tool adjustment unit 14 can be adjusted about an axis located transverse to the driving axle or transverse to the tool's axis of rotation. If there is for instance a tool with a tool tip present in the tool receiving unit 11, the radius of the circular flight path of the rotating tool tip can be changed by adjustment.

A measuring sensor range 10 is arranged on the tool adjustment unit 14.

Spindle 1 arranged on corresponding sliding frames, slides and pivoting devices can be relatively shifted with respect to a stationary or a rotating tool either axially, radially, or in another way desired, depending on the application. Correspondingly, the tool can be brought up to the surface of the workpiece for the corresponding machining operation. Also a simple drill can be inserted as a tool in the tool receiving unit, as well as a milling cutter, with intermediate arrangement of adapters, drill chucks, and the like, if applicable. In this case, it makes sense to lock or jam the adjustable tool adjustment unit 14 to prevent it from shifting.

Channels provided inside the spindle serve to carry hydraulics, pneumatics, and also coolants, for which purpose corresponding connections are provided, which are not shown. Via the terminals 16 of an electrical measuring signal distributor, the measuring signals of the measuring system 10 are transmitted to a controller not shown in detail in the figures.

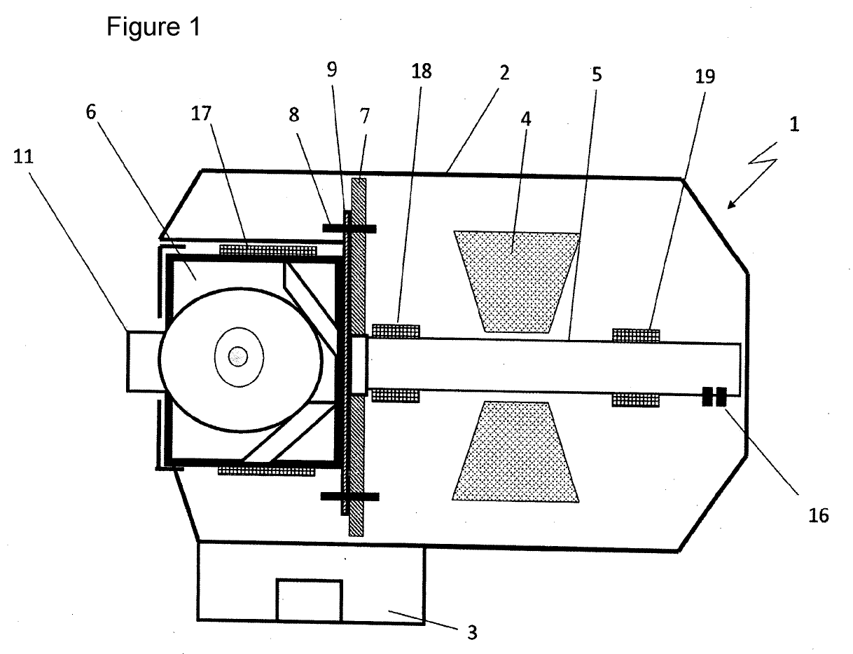

As can be seen in particular from FIG. 1, shaft 5 of the spindle is supported via a spindle bearing arrangement which, in the exemplary embodiment shown, comprises ball bearings 17, 18, and 19.

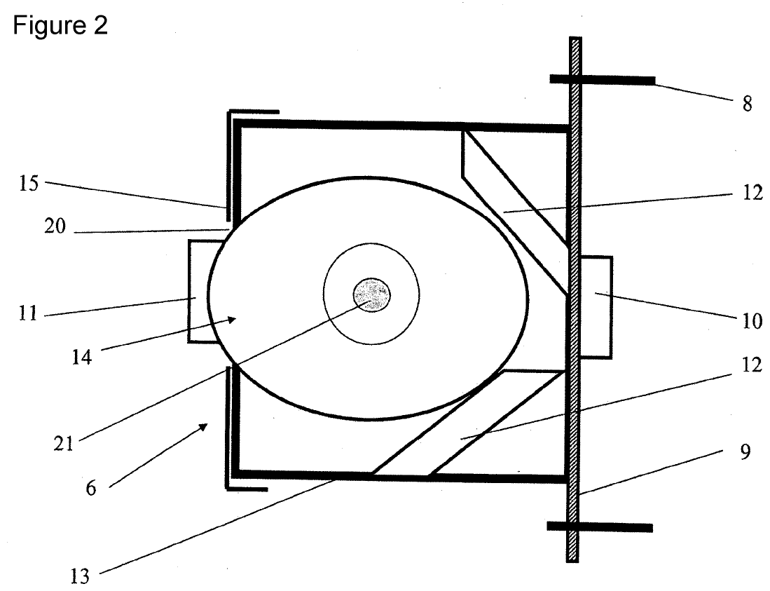

As can be seen from FIG. 2, the tool adjustment unit 14 pivots with respect to shaft 5 about the pivoting axis 21. The maximum pivoting range in this respect is identified by reference numeral 20.

Only in an exemplary fashion, the adjustable tool receiving unit is arranged in a housing in the exemplary embodiment shown. This housing is connected to a mounting flange 9, which can be fastened by means of fastening screws 8 to a base plate 7 on the spindle side.

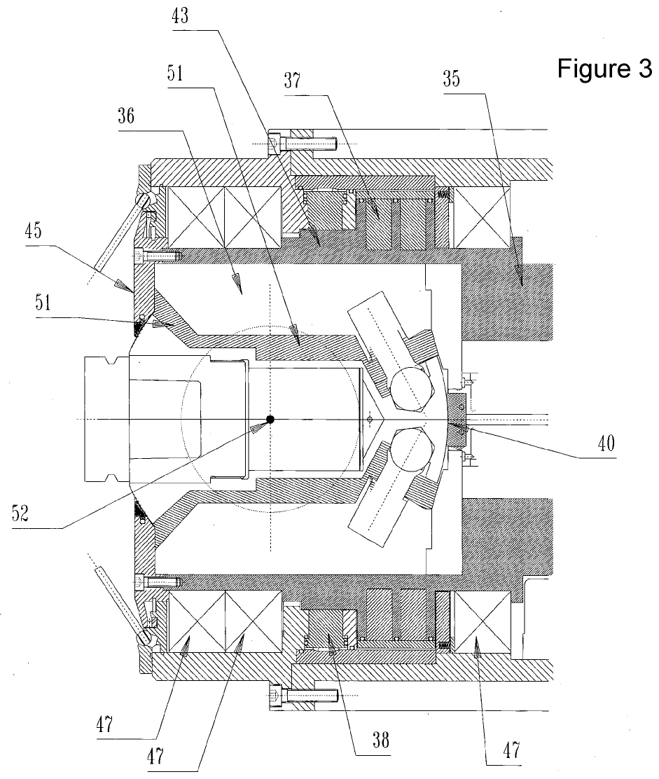

FIGS. 3, 4 and 5 show a concrete embodiment of a spindle according to the disclosure. In these figures, identical elements are identified by the same reference numerals.

An exemplary embodiment of a tool spindle 31 according to the disclosure comprises a spindle housing.

A power unit 34 with a corresponding motor is formed within the housing. Ultimately, the driving forces are applied to a shaft 35.

A tool adjustment device 36 is directly integrated into the shaft 35, in which a tool adjustment unit 44 is integrated. A tool receiving unit 41 passes through a kind of lock 45. A tool interface accommodates a machining tool. The assembly 36/44 is directly integrated into shaft 35, so that the device can be set in rotary motion. By means of the piston assembly 42, the tool adjustment unit 44 can be adjusted about an axis located transverse to the driving axle or transverse to the tool's axis of rotation. If there is for instance a tool with a tool tip present in the tool receiving unit 41, the radius of the circular flight path of the rotating tool tip can be changed by adjustment.

A measuring sensor range 40 is arranged on the tool adjustment unit 44.

Spindle 31 arranged on corresponding sliding frames, slides and pivoting devices can be relatively shifted with respect to a stationary or a rotating tool either axially, radially, or in another way desired, depending on the application. Correspondingly, the tool can be brought up to the surface of the workpiece for the corresponding machining operation. Also a simple drill can be inserted as a tool in the tool receiving unit, as well as a milling cutter, with intermediate arrangement of adapters, drill chucks, and the like, if applicable. In this case, it makes sense to lock or jam the adjustable tool adjustment unit 44 to prevent it from shifting.

The rotary distributor 29 represented inside the spindle serve to carry hydraulics, pneumatics, and also coolants, for which purpose corresponding connections are provided, which are not shown. Via the terminals 46 of an electrical measuring signal distributor, the measuring signals of the measuring system 10 are transmitted to a controller not shown in detail in the figures.

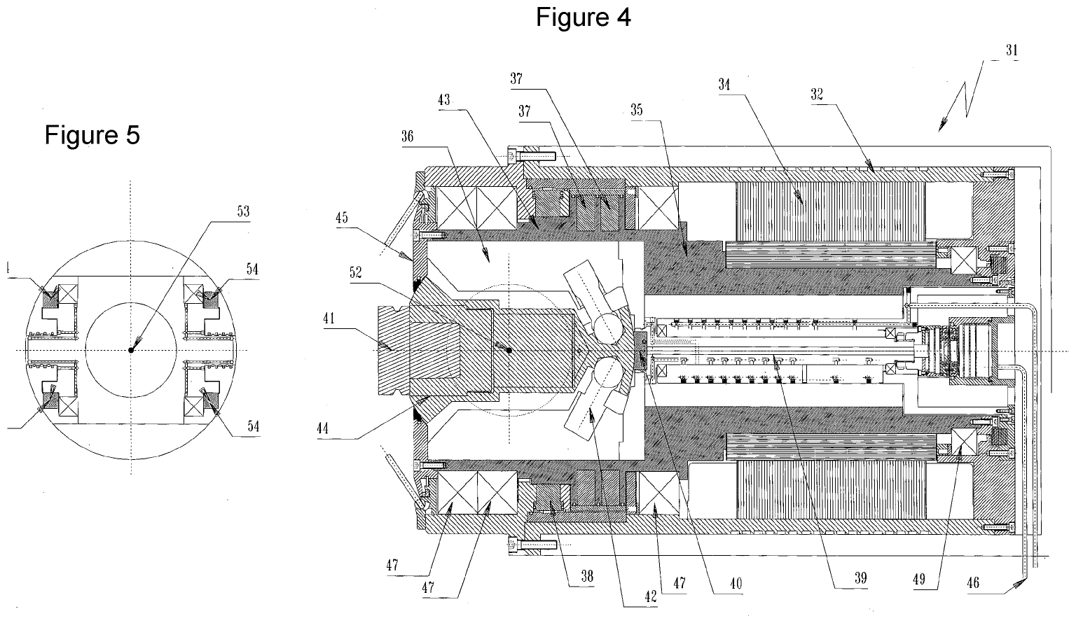

As can be seen in particular from FIG. 4, shaft 35 of the spindle is supported via a spindle bearing arrangement which, in the exemplary embodiment shown, comprises ball bearings 47 and 49.

As can be seen from FIG. 3, the tool adjustment unit 44 pivots with respect to shaft 35 about the pivoting axis 52. The maximum pivoting range in this respect is identified by reference numeral 51.

Only in an exemplary fashion, the adjustable tool receiving unit is arranged in a housing 43 in the exemplary embodiment shown. In the exemplary embodiment shown, this tool receiving unit is formed integrally with shaft 35.

It can be seen from the shown exemplary embodiment that the power unit/the motor 34 comprises only one driving source.

The reference numeral 37 identifies imbalance compensation discs which are adjustable in order to compensate imbalances in this manner.

The spindle can on principle be immobilised, for which purpose the spindle clamping 38 is to be inserted. The adjustment axis may be immobilised, too, for which purpose the clamps 54 for the adjustment axis are inserted, as shown in FIG. 5. The axis of rotation of the spindle is referenced with 53.

In the exemplary embodiment shown, all data and supply lines are led through the rotary distributor 39.

The description of the exemplary embodiment only serves a better understanding and is not restrictive.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A tool spindle comprising a spindle housing, a rotary drive, and a tool receiving unit, with a driving motor acting on a rotating driving axle, and comprising the tool receiving unit arranged rotatably around the driving axle, which tool receiving unit is connected with the driving axle via a transmission chain and is arranged within the spindle housing and is movable with respect to the housing,
wherein
the tool receiving unit is arranged in a housing and can be moved with respect to the spindle housing about an axis located transverse to the driving axle.

2. The tool spindle according to claim 1, wherein the spindle housing is shaped cylindrically.

3. The tool spindle according to claim 1, wherein the tool receiving unit is mechanically lockable with respect to the shaft by means of a locking mechanism of a tool adjustment unit.

4. The tool spindle according to claim 1, wherein within the tool spindle, channels are formed to carry coolant.

5. The tool spindle according to claim 1, wherein at least one unit present in the transmission chain is provided with a unit for imbalance compensation.

6. The tool spindle according to claim 5, wherein the unit for imbalance compensation comprises displaceable ring segments.

7. The tool spindle according to claim 1, wherein the shaft can be locked.

8. The tool spindle according to claim 1, wherein the tool adjustment unit is located within the front and rear bearing arrangement of the driving shaft.

9. The tool spindle according to claim 1, wherein the tool adjustment unit is integrated into the shaft of the tool spindle.

10. The tool spindle according to claim 1, wherein rotary joint channels for hydraulics are provided.

11. The tool spindle according to claim 1, wherein rotary joint channels for pneumatics are provided.

12. The tool spindle according to claim 1, wherein rotary joint channels for electrical equipment are provided.
